(19) United States
(12) Patent Application Publication
(10) Pub. No.: US 2026/0289032 A1
(43) Pub. Date: Sep. 24, 2026

(54) ISLANDED POWER SYSTEM FOR LARGE DATA CENTERS

(71) Applicant: Kraken Technology Holdings, LLC, Houston, TX (US)

(72) Inventors: Bengt Arne JARLSJO, Houston, TX (US); Sanjeev MENON, Plainfield, IL (US); Byron Gladus BEST, III, Katy, TX (US); Daniel Joseph SHAPIRO, Houston, TX (US); John Michael JONES, Houston, TX (US); Ulf Hakan JARLSJO, Norrköping (SE); Michael Arne JARLSJO, Houston, TX (US)

(73) Assignee: Kraken Technology Holdings, LLC, Houston, TX (US)

(21) Appl. No.: 19/559,580

(22) Filed: Mar. 6, 2026

Related U.S. Application Data
(60) Provisional application No. 63/768,720, filed on Mar. 7, 2025.

(51) Int. Cl. G06F 30/13

(52) U.S. Cl. CPC G06F 30/13

(57) ABSTRACT

A method for designing and operating a power supply system for one or more AI data centers operating in an islanded power system environment is disclosed. The method includes receiving input data describing projected electrical load characteristics of the one or more AI data centers, identifying system requirements and constraints, defining a plurality of candidate equipment configurations and operating conditions for the power supply system configured to operate independently of an external electrical grid, simulating performance of the plurality of candidate equipment configurations and operating conditions across a plurality of time intervals representing projected system operation, calculating a NPV cost associated with designing, constructing, and operating each candidate equipment configuration over a defined period of time, evaluating whether each candidate configuration satisfies the system requirements and constraints, and selecting a configuration of equipment and operating conditions that minimizes the NPV cost while satisfying the system requirements and constraints.

This application claims the priority benefit of U.S. Provisional Appl. No. 63/768,720, filed Mar. 7, 2025, which is incorporated herein by reference in its entirety.

### BACKGROUND

The present invention relates to the field of electrical power systems, specifically to the economical design and operation of islanded power systems for large-scale data centers.

“Islanded Power Systems” as used throughout this application means data centers that have power generation directly electrically connected to them; this instead of taking power from the electrical transmission system and having no power generation or only back-up power generation, connected to the data centers. Note that this includes data centers that take some of their generation from the transmission grid and non-emergency generation assets connected directly or indirectly to the on-site or near-site data centers.

The present invention involves a process approach to minimizing the cost of ownership, design and operations of Islanded Power Systems, considering data center requirements that may change over time, as may the available power generation and how the equipment is operated, the many constraints that apply to Islanded Power Systems such as environmental permitting, impact on local communities, impacts on off-site electrical power consumers/utility power company customers, delivery and construction timelines, equipment already purchased, operations and maintenance, equipment performance degradation over time, land constraints, the availability of fuels, availability of power grid transmission lines, interconnections, etc.

The rapid proliferation of AI-driven applications and other uses of AI have led to the emergence of hyperscale data centers with variable power demands. Up until the booming AI compute market, data centers were smaller and typically connected to the power grid and had relatively stable load shapes. As such, they did not have a reason to optimize the on-site power generation equipment and operating conditions of such equipment. No established approach existed and most Islanded Power Systems were designed to just provide power without going through an approach to optimizing the equipment and the operating conditions of such equipment.

Conventional data centers, typically grid-connected, rely on established methods to manage transient loads and maintain power quality. These methods, however, are insufficient for Islanded Power Systems—particularly at the scale required by modern AI data centers—which may experience rapid and frequent load swings ranging as large as several GWs while also having transient electrical changes that can cause disruption to the electrical equipment. Existing solutions do not adequately address the needs for scalability, redundancy, and instantaneous response to load fluctuations in such isolated environments, especially not when it comes to optimizing the net present value (“NPV”) from addressing such extreme load swings and varying power quality requirements and impacts from large data center loads.

Furthermore, the prior art fails to provide integrated approaches to consider and test different operating conditions on the power and electrical equipment, such as running extra equipment at partial load to have spinning reserves that can respond faster to load changes compared to some power generation equipment running at 100% while some are on stand-by and, as such, at 0% load—while combining battery energy storage systems (“BESS”), synchronous condensers, capacitive compensation, and dynamic, interruptible base loads, to stabilize Islanded Power Systems during severe load transients, and maximizing NPV.

### SUMMARY OF INVENTION

A method for designing and operating a power supply system for one or more artificial intelligence (AI) data centers operating in an islanded power system environment is disclosed. The method includes receiving input data describing projected electrical load characteristics of the one or more AI data centers, identifying system requirements and constraints, defining a plurality of candidate equipment configurations and operating conditions for the power supply system configured to operate independently of an external electrical grid, simulating performance of the plurality of candidate equipment configurations and operating conditions across a plurality of time intervals representing projected system operation, calculating a net present value (NPV) cost associated with designing, constructing, and operating each candidate equipment configuration over a defined period of time, evaluating whether each candidate configuration satisfies the system requirements and constraints, and selecting a configuration of equipment and operating conditions that minimizes the NPV cost while satisfying the system requirements and constraints. The system requirements and constraints may be selected from power supply reliability, power quality requirements, equipment limits, operational limits, and regulatory or environmental constraints. The candidate operating conditions comprise variable operating levels of power generation equipment, including operation of multiple generators at partial load to maintain spinning reserves capable of responding to rapid load changes.

The selecting step comprises evaluating tradeoffs between: (a) operating power generation equipment at partial load to provide fast-response spinning reserves; and (b) operating power generation equipment at full output or in a non-spinning standby condition. The candidate equipment configurations may comprise one or more of battery energy storage systems (BESS), synchronous condensers configured to provide inertia and reactive power support, BESS and synchronous condensers configured to provide grid-forming capability for the islanded power system, high-capacity capacitor banks configured to regulate voltage and reactive power, and dynamically controlled interruptible loads comprising computational workloads capable of being rapidly curtailed or enabled to balance electrical supply and demand, wherein the interruptible loads comprise cryptocurrency mining or other computationally intensive processes capable of rapid power modulation. The selecting step may also comprise determining an amount of interruptible load capacity required to mitigate frequency or voltage instability during severe load transients.

The projected load characteristics include rapid load swings exceeding one gigawatt within a short time interval, such as multi-gigawatt load swings occurring over time intervals of less than several minutes or even less than one second. The NPV cost includes capital expenditures, operational expenditures, fuel costs, maintenance costs, and equipment replacement costs. The system requirements include frequency stability limits, voltage stability limits, and spinning reserve requirements. The candidate configurations comprise redundancy configurations for critical equipment including N+2 redundancy architectures and similar configurations for including overall electrical system availability.

### BRIEF DESCRIPTION OF THE FIGURES

The features and advantages of the present invention will be more clearly understood from the following description taken in conjunction with the accompanying figures in which:

FIG. 1 illustrates the process approach of enabling the systematic evaluation and economic optimization of power system configurations designed to support AI data centers exhibiting extreme and rapid load fluctuations, in accordance with certain teachings of the present invention.

### DETAILED DESCRIPTION

The present invention provides a comprehensive, scalable optimization process for enhancing the NPV cost of designing and powering Islanded Power Systems for AI data centers. The process scales to data centers of any size with the value increasing proportionally with scale. By varying operating conditions while integrating BESS, synchronous condensers, high-capacity capacitor banks, and dynamically controlled interruptible loads—such as cryptocurrency mining operations—the present invention aims to cost-effectively manage frequency and voltage fluctuation inside targeted ranges while managing rapid load swings and transient electrical changes while maintaining targeted power reliability and efficiency. The approach is adaptable, in that it includes plans for future re-optimization as the available equipment, customer/data center requirements change over time due to changes in AI data center equipment, power equipment changes and availability, and equipment degradation, while minimizing the NPV of complying with all requirements and constraints as circumstances change over time.

A first embodiment of the present invention provides an optimizing process for Islanded Power Systems serving data centers with on-site generation that is not limited to emergency back-up operations. Input parameters for the process and configuration include: (a) variable operating conditions on the power and electrical equipment, such as running extra equipment at partial load to have spinning reserves that can respond faster to load changes—as compared to power generation equipment running at 100%, or to generators that are not spinning and cannot decrease load or quickly respond to demand changes; (b) BESS and synchronous condensers for dynamic voltage and frequency stabilization, ensuring robust grid-forming capability during rapid load changes; (c) high-capacity capacitor banks providing fast-acting reactive power support to accommodate transient and peak load events; (d) dynamically controlled interruptible baseloads—such as cryptocurrency mining or other computationally intensive processes—that can be rapidly curtailed or enabled to balance supply and demand; and (e) advanced control algorithms for real-time monitoring and management of system stability, redundancy (such as N+2 configurations of critical equipment), and related adaptations to unpredictable AI workload fluctuations. The integration of interruptible loads enables immediate response to severe load transients, significantly reducing the risk of frequency or voltage instability and eliminating the need for traditional load-shedding practices, while optimizing NPV costs.

In an illustrative embodiment of the present invention, a 5 GW peak (1 GW baseline, swinging to 5 GW hourly) islanded AI data center incorporates an N+2 redundancy requirement, that is, the power configuration provides high availability by having the minimum required components (N) plus two additional backup units (+2) to handle failures. For example, the power generation system may comprise 89 base turbines (Siemens SGT-800 combined cycle gas turbine (“CCGT”)) operating nominally at 58 MW/turbine, with 2 additional turbines to provide N+2 redundancy. The islanded power system handles 4 GW hourly up-and-down load swings (1 GW to 5 GW and back, 8,760 cycles/year) with no interruptible load shedding and allows frequency drops. An additional 1 GW of synchronous condensers and 1,800 MVAR capacitors are incorporated, adjusting for N+2. With N+2 redundancy (91 turbines, 5,278 MW online), 1 GW condensers (6,000 MW-s, 1,000 MVAR), and 1,800 MVAR capacitors, the power generation system limits frequency to 59.771-60.229 Hz (0.458 Hz range), recovers in 5-6 seconds, and stabilizes voltage at ±0.5-1%, costing $12.2B in capital upfront and $1.1B/year-totaling $ 23.462B over 10 years. This cost represents an approximately $ 641 M increase over a N+1 system ($22.821B), which buys exceptional uptime. Compared to a typical grid, this optimized power system offers superior redundancy (N+2 vs. N+1) and voltage control, matches contingency frequency stability, but sees wider routine excursions due to hourly swings.

In a second illustrative embodiment, for a more severe application, another 1 GW of CCGT generation and a cryptocurrency mining operation is incorporated, the crypto mining operation serving as interruptible baseload so that the CCGT baseload is served even when the AI data load is 0 MW, and it instantly drops off when there is a power ramp so that it provides a swing load in both load increases from 0 to 5 GW and load decreases from 5 GW to 0 MW. In other words, for load increases, the crypto mining load is dropped. For load decreases, the crypto mining load is added. In short, the crypto mining load serves as an instant load increase/decrease for more severe AI data load swings.

A second embodiment of the present invention provides a method for designing and operating a power supply system for one or more AI data centers operating in an islanded power system environment is disclosed. The method includes receiving input data describing projected electrical load characteristics of the one or more AI data centers, identifying system requirements and constraints, defining a plurality of candidate equipment configurations and operating conditions for the power supply system configured to operate independently of an external electrical grid, simulating performance of the plurality of candidate equipment configurations and operating conditions across a plurality of time intervals representing projected system operation, calculating a NPV cost associated with designing, constructing, and operating each candidate equipment configuration over a defined period of time, evaluating whether each candidate configuration satisfies the system requirements and constraints, and selecting a configuration of equipment and operating conditions that minimizes the NPV cost while satisfying the system requirements and constraints. The system requirements and constraints are selected from power supply reliability, power quality requirements, equipment limits, operational limits, and regulatory or environmental constraints. The candidate operating conditions comprise variable operating levels of power generation equipment, including operation of multiple generators at partial load to maintain spinning reserves capable of responding to rapid load changes.

The selecting step comprises evaluating tradeoffs between: (a) operating power generation equipment at partial load to provide fast-response spinning reserves; and (b) operating power generation equipment at full output or in a non-spinning standby condition. The candidate equipment configurations may comprise one or more of battery energy storage systems (BESS), synchronous condensers configured to provide inertia and reactive power support, BESS and synchronous condensers configured to provide grid-forming capability for the islanded power system, high-capacity capacitor banks configured to regulate voltage and reactive power, and dynamically controlled interruptible loads comprising computational workloads capable of being rapidly curtailed or enabled to balance electrical supply and demand, wherein the interruptible loads comprise cryptocurrency mining or other computationally intensive processes capable of rapid power modulation. The selecting step may also comprise determining an amount of interruptible load capacity required to mitigate frequency or voltage instability during severe load transients. The projected load characteristics include rapid load swings exceeding one gigawatt within a short time interval, such as multi-gigawatt load swings occurring over time intervals of less than several minutes or even less than one second. The NPV cost includes capital expenditures, operational expenditures, fuel costs, maintenance costs, and equipment replacement costs. The system requirements include frequency stability limits, voltage stability limits, and spinning reserve requirements. The candidate configurations comprise redundancy configurations for critical equipment including N+2 redundancy architectures and similar configurations for including overall electrical system availability.

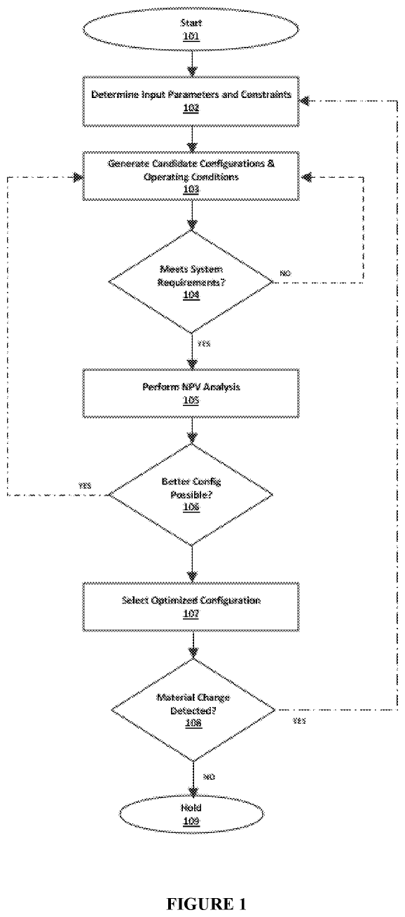

With reference to FIG. 1, a process for enabling the systematic evaluation and economic optimization of power system configurations is designed to support AI data centers exhibiting extreme and rapid load fluctuations is provided in accordance with certain teachings of the present invention.

In Step 101, an optimization cycle configured to evaluate multiple system configurations is initiated.

In Step 102, the required parameters for the AI data center are determined. Exemplary parameters include, but are not limited to, load growth over time and power quality requirements, together with project constraints such as air permits, site conditions, availability of electrical equipment, fuel availability, water availability, nearby community/residential considerations, and local, state, and federal zoning and commercial constraints from customers or Other stakeholders. A set of technical, operational, regulatory, environmental, and commercial constraints is thereby established, defining the permissible design space for evaluating candidate system configurations.

In Step 103, a combination of equipment configuration and operating conditions is selected that is likely to meet the requirements established in Step 102 in an efficient and cost-effective manner.

In Step 104, it is determined whether the candidate configuration and operating conditions—including voltage stability, frequency stability, redundancy thresholds, inertia requirements, and dynamic response capabilities—meet all requirements established in Step 102. If so, then proceed to Step 105. If not, return to Step 103 to consider a different configuration. If no compliant configuration can be found after exhausting all acceptable options, then the project is paused until an improved technical or operating conditions solution has been identified or an alternative project site has been located.

In Step 105, an NPV analysis is performed for each viable equipment configuration and operating conditions combination passing Step 104. The analysis includes items and methods familiar to those with expertise in the financial modeling of energy infrastructure assets, including capital investments, operational costs, fuel costs, maintenance costs, revenues, taxes, and the impact of financing, among others.

In Step 106, changes in equipment configuration or operating conditions are evaluated to improve the NPV value determined in Step 105. The evaluation of numerous options can be accomplished using traditional methods or by utilizing artificial intelligence to improve the speed, cost efficiency, and breadth of configurations and operating conditions that can be considered within a reasonable timeframe and budget. If a potentially better solution is identified, then return to Step 103. The iterative loop continues until a sufficient number of reasonable configurations have been evaluated, at which point the process proceeds to Step 107.

In Step 107, having completed the iterative process in Steps 102 through 106, the solution that is most optimized—or at minimum sufficiently cost-effective to justify proceeding—is selected. The equipment configuration and operating conditions are held at this basis until the input parameters or constraints change materially. For example, if improved power generation equipment becomes commercially available, the process restarts from Step 102 and optimization begins anew. As such, the present invention is applied over the lifetime of the power generation facility and updated from time to time as equipment availability and performance change, or as input parameters or constraints are revised. This results in continuous improvement as circumstances evolve.

In Step 108, the method of the present invention periodically evaluates—or evaluates upon material triggering events—whether a material change has occurred in the input parameters or constraints. Material changes may include permitting updates, equipment procurement changes, newly available or updated technology, customer load revisions, site developments, or community concerns. If such a change has occurred, the method returns to Step 102 to re-optimize the NPV cost and revenue profile.

In Step 109, the optimized configuration remains in effect until a new triggering event necessitates re-execution of the optimization process.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. It is therefore evident that the particular embodiments disclosed above may be altered or modified and all such variations are considered within the scope and spirit of the present invention.

What is claimed is:

1. A method for designing and operating a power supply system for one or more artificial intelligence (AI) data centers operating in an islanded power system environment, the method comprising:
receiving input data describing projected electrical load characteristics of the one or more AI data centers;
identifying system requirements and constraints for the power supply system;
defining a plurality of candidate equipment configurations and operating conditions for the power supply system configured to operate independently of an external electrical grid;
simulating performance of the plurality of candidate equipment configurations and operating conditions across a plurality of time intervals representing projected system operation;
calculating a net present value (NPV) cost associated with designing, constructing, and operating each candidate equipment configuration over a defined period of time;
evaluating whether each candidate equipment configuration satisfies the system requirements and constraints; and
selecting a configuration of equipment and operating conditions that minimizes the NPV cost while satisfying the system requirements and constraints.

2. The method of claim 1, wherein the system requirements and constraints are selected from power supply reliability, power quality requirements, equipment limits, operational limits, and regulatory or environmental constraints.

3. The method of claim 1, wherein the candidate operating conditions comprise variable operating levels of power generation equipment, including operation of multiple generators at partial load to maintain spinning reserves capable of responding to rapid load changes.

4. The method of claim 3, wherein the selecting step comprises evaluating tradeoffs between: (a) operating power generation equipment at partial load to provide fast-response spinning reserves; and (b) operating power generation equipment at full output or in a non-spinning standby condition.

5. The method of claim 1, wherein the candidate equipment configurations comprise battery energy storage systems (BESS).

6. The method of claim 1, wherein the candidate equipment configurations comprise synchronous condensers configured to provide inertia and reactive power support.

7. The method of claim 1, wherein the candidate equipment configurations comprise battery energy storage systems (BESS) and synchronous condensers configured to provide grid-forming capability for the islanded power system.

8. The method of claim 1, wherein the candidate equipment configurations comprise high-capacity capacitor banks configured to regulate voltage and reactive power.

9. The method of claim 1, wherein the candidate equipment configurations comprise dynamically controlled interruptible loads comprising computational workloads capable of being rapidly curtailed or enabled to balance electrical supply and demand.

10. The method of claim 9, wherein the interruptible loads comprise cryptocurrency mining or other computationally intensive processes capable of rapid power modulation.

11. The method of claim 1, wherein the selecting step comprises determining an amount of interruptible load capacity required to mitigate frequency or voltage instability during severe load transients.

12. The method of claim 1, wherein the projected load characteristics include rapid load swings exceeding one gigawatt within a short time interval.

13. The method of claim 12, wherein the process accounts for multi-gigawatt load swings occurring over time intervals of less than several minutes.

14. The method of claim 12, wherein the process accounts for multi-gigawatt load swings occurring over time intervals of less than one second.

15. The method of claim 1, wherein the NPV cost includes capital expenditures, operational expenditures, fuel costs, maintenance costs, and equipment replacement costs.

16. The method of claim 1, wherein the system requirements include frequency stability limits, voltage stability limits, and spinning reserve requirements.

17. The method of claim 1, wherein the candidate configurations comprise redundancy configurations for critical equipment including N+2 redundancy architectures and similar configurations for including overall electrical system availability.
